(19) United States
(12) Patent Application Publication
(10) Pub. No.: US 2012/0054670 A1
(43) Pub. Date: Mar. 1, 2012

(54) APPARATUS AND METHOD FOR SCROLLING DISPLAYED INFORMATION

(75) Inventor: ROOPE RAINISTO, Helsinki (FI)

(73) Assignee: Nokia Corporation

(21) Appl. No.: 12/870,278

(22) Filed: Aug. 27, 2010

(51) Int. Cl. G06F 3/041; G06F 3/048

(52) U.S. Cl. 715/784; 345/173

(57) ABSTRACT

In accordance with an example embodiment of the present invention, a method is provided for controlling scrolling of displayed information, comprising: causing a scrolling action on the basis of a scrolling input, detecting a hovering input on the basis of sensing presence of an object in close proximity to an input surface during the scrolling action, and adapting at least one parameter associated with the scrolling action in accordance with the hovering input.

### FIELD

The present invention relates to an apparatus and a method for scrolling displayed information.

### BACKGROUND

Touch screens are used in many portable electronic devices, for instance in PDA (Personal Digital Assistant) devices, tabletops, and mobile devices. Touch screens are operable by a pointing device (or stylus) and/or by a finger. Typically the devices also comprise conventional buttons for certain operations.

In general, scrolling touch screen contents may be done by flicking the page, i.e. doing a quick swiping motion by a finger on screen and then lifting the finger up. The contents continue to scroll, depending on the speed of the initial flick. Such “kinetic scrolling” has become a popular interaction method in touch screen devices.

### SUMMARY

Various aspects of examples of the invention are set out in the claims.

According to an aspect, an apparatus is provided, comprising at least one processor; and at least one memory including computer program code, the at least one memory and the computer program code configured to, with the at least one processor, cause the apparatus at least to perform: cause a scrolling action on the basis of a scrolling input, detect a hovering input on the basis of sensing presence of an object in close proximity to an input surface during the scrolling action, and adapt at least one parameter associated with the scrolling action in accordance with the hovering input.

According to an aspect, a method is provided, comprising: causing a scrolling action on the basis of a scrolling input, detecting a hovering input on the basis of sensing presence of an object in close proximity to an input surface during the scrolling action, and adapting at least one parameter associated with the scrolling action in accordance with the hovering input.

According to an example embodiment, acceleration or retardation of scrolling is adapted in accordance with the hovering input.

According to another example embodiment, a hovering gesture is detected during the scrolling action, and the at least one parameter associated with the scrolling action is controlled in accordance with the hovering gesture.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 shows an example of an electronic device in which displayed information may be scrolled;

FIG. 2 is a simplified block diagram of a side view of an input apparatus in accordance with an example embodiment of the invention;

FIGS. 3 to 5 illustrate methods according to example embodiments of the invention; and

FIG. 6 illustrates an electronic device in accordance with an example embodiment of the invention.

### DETAILED DESCRIPTION

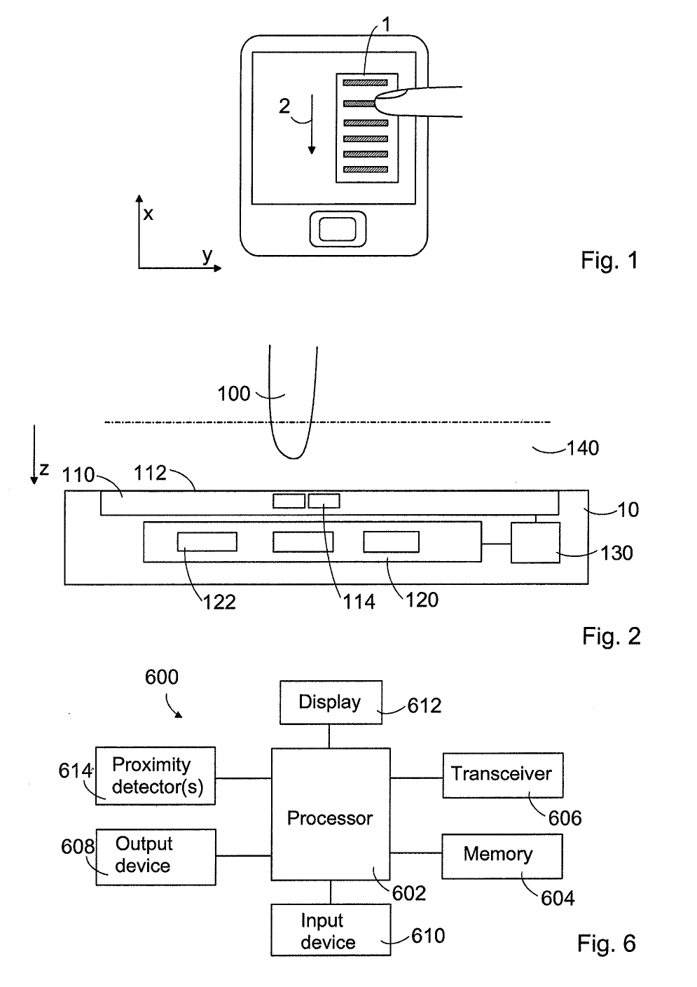

FIG. 1 illustrates an example of scrolling of displayed information 1, for instance a list of displayed items on a hand-held electronic device. Scrolling generally refers to moving all or part of a display image to display data that cannot be observed within a single display image. Scrolling may also refer to finding a desired point in a file being outputted or played, for example finding of particular point in a music file by moving a slider or another type of graphical user interface (GUI) element to travel backward/forward within the file. Scrolling may be triggered in response to detecting a flicking input by a finger or a stylus, for instance. Displayed information items may be moved to a direction indicated by reference number 2 in the example of FIG. 1. In some cases a user may need to scroll through a very long page, which may require even 10 to 20 flicking inputs to reach the end of the page. Repeated flicking is needed because a friction component is usually present in flick scrolling designs: when the user flicks the content forward, the scrolling speed starts to decrease, similarly to how friction would slow down a curling stone thrown on ice.

In some example embodiments hovering is used to control scrolling. Hovering refers generally to introduction of an input object, such as a finger or a stylus, in close proximity to, but not in contact with, an input surface, such as an input surface of a touch screen. A hovering input may be detected based on sensed presence of an input object in close proximity to an input surface during the scrolling action. The hovering input may be detected based on merely sensing the introduction of the input object in the close proximity to the input surface, or the detection of the hovering input may require some further particular movement or gesture by the input object, for instance. In some example embodiments at least one parameter associated with the scrolling action is adapted in accordance with a hovering input. This is to be broadly understood to refer to any type of change affecting the scrolling of, for example, displayed information. Some examples of such parameters affecting the scrolling can include variables like a friction coefficient or speed of scrolling.

For instance, if the user keeps his finger close to the input surface, friction operation may be partly or completely removed and the information may be maintained scrolling at constant or even increased speed. In another example, when the user wants to end the scrolling, he may simply takes his finger further away from the input surface, whereby the friction component is applied or the scrolling is instantly stopped.

This enables further and intuitive input options to control scrolling. In some example embodiments it may become possible to reduce the amount of physical inputs needed to achieve an intended scrolling result when viewing e.g. a page or menu of which only a small portion is visible for the user at a time.

FIG. 2 illustrates an example apparatus 10 with one or more input and/or output devices. The input devices may for example be selected from buttons, switches, sliders, keys or keypads, navigation pads, touch pads, touch screens, and the like. The output devices may be selected from displays, speakers, indicators, for example.

The apparatus 10 comprises a display 110 and a proximity detection system or unit 120 configured to detect when an input object 100, such as a finger or a stylus, is brought in close proximity to, but not in contact with, an input surface 112. The input surface 112 may be a surface of a touch screen or other input device of the apparatus capable of detecting user inputs.

A sensing area 140 may illustrate the approximate area and/or distance at which an input object 100 is detected to be in close proximity to the surface 112. The sensing area 140 may also be referred to as a hovering area and introduction of an input object 100 to the hovering area and possible further (non-touch) inputs by the object 100 in the hovering area may be referred to as hovering. The input object 100 may be detected to be in the close proximity to the input surface and thus in the hovering area 140 on the basis of a sensing signal or the distance of the input object 100 to the input surface 112 meeting a predefined threshold value. In some embodiments the hovering area 140 enables also inputting and/or accessing data in the apparatus 10, even without touching the input surface 112. A user input, such as a particular detected gesture, in the hovering area 140 detected at least partly based on the input object 100 not touching the input surface 112 may be referred to as a hovering input. Such hovering input is associated with at least one function, for instance selection of an UI item, zooming a display area, activation of a pop-up menu, or causing/controlling scrolling of displayed information.

The apparatus 10 may be a peripheral device, such as a keyboard or mouse, or integrated in an electronic device. Examples of electronic devices include any consumer electronics device like computers, media players, wireless communications terminal devices, and so forth.

In some embodiments, a proximity detection system 120 is provided in an apparatus comprising a touch screen display. Thus, the display 110 may be a touch screen 110 comprising a plurality of touch sensitive detectors 114 to sense touch inputs to touch screen input surface.

In some embodiments the detection system 120 generates a sensing field by one or more proximity sensors 122. In one example embodiment a capacitive proximity detection system is applied, whereby the sensors 122 are capacitive sensing nodes. Disturbances by one or more input objects 100 in the sensing field are monitored and presence of one or more objects is detected based on detected disturbances. A capacitive detection circuit 120 detects changes in capacitance above the surface of the touch screen 110.

However, it will be appreciated that the present features are not limited to application of any particular type of proximity detection. The proximity detection system 120 may be based on infrared proximity detection, optical shadow detection, acoustic emission detection, ultrasonic detection, or any other suitable proximity detection technique. For instance, in case the proximity detection system 120 would be based on infrared detection, the system would comprise one or more emitters sending out pulses of infrared light. One or more detectors would be provided for detecting reflections of that light from nearby objects 100. If the system detects reflected light, then an input object is assumed to be present.

The detection system 120 may be arranged to estimate (or provide a signal enabling estimation of) the distance of the input object 100 from the input surface 112, which enables to provide z coordinate data of the location of the object 100 in relation to the input surface 112. The proximity detection system 120 may also be arranged to generate information on x, y position of the object 100 in order to be able to determine a target UI item or area of a hovering input. X and y directions are generally substantially parallel to the input surface 112, and the z direction is substantially normal to input surface 112. Depending on the proximity detection technique applied, the size of the apparatus 10 and the input surface 112, and the desired user interaction, the hovering area 140 may be arranged to extend from the input surface 112 by distance selected from some millimetres to even up to multiple dozens of centimetres, for instance. The proximity detection system 120 may enable detection of also further parts of user's hand, and the system may be arranged to recognize false inputs and avoid further actions.

In the example of FIG. 2, the proximity detection system 120 is coupled to a controller 130. The proximity detection system 120 is configured to provide the controller 130 with signals when an input object 100 is detected in the hovering area 140. Based on such input signals, commands, selections and other types of actions may be initiated, typically causing visible, audible and/or tactile feedback for the user. Touch inputs to the touch sensitive detectors 114 may be signalled via a control circuitry to the controller 130, or another controller.

The controller 130 may also be connected to one or more output devices, such as the touch screen display 110. The controller 130 may be configured to control different application views on the display 110. The controller 130 may detect touch inputs and hovering inputs on the basis of the signals from the proximity detection system 120 and the touch sensitive detectors 114. The controller 130 may then control a display function associated with a detected touch input or hovering input. It will be appreciated that the controller 130 functions may be implemented by a single control unit or a plurality of control units.

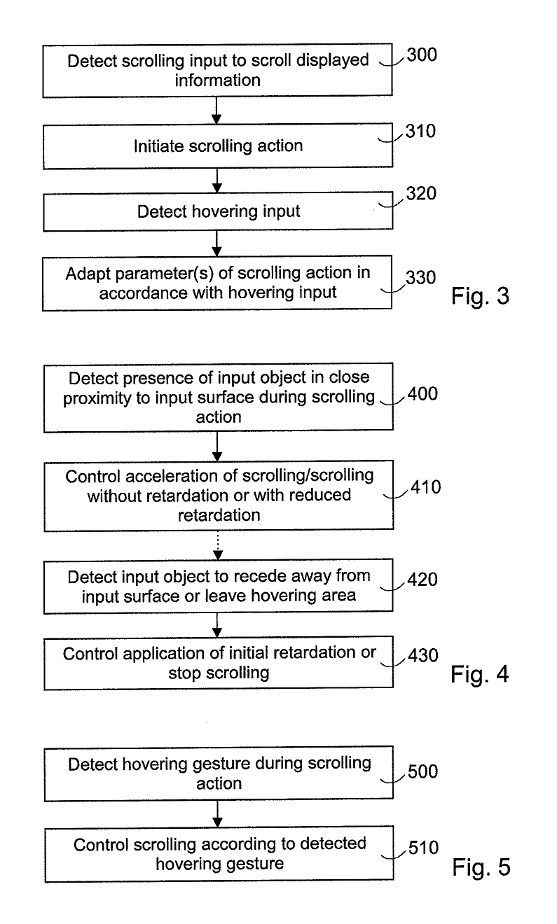

The controller 130 may be arranged to detect a touch or non-touch based scrolling input and cause scrolling of information on the display. Further, in response to being provided with a signal by the proximity detection system 120 indicating a hovering input during the scrolling action, the controller may adapt one or more parameters of the scrolling action, e.g. by selecting a parameter from a set of pre-stored parameters associated with the detected hovering action. Some further example features, at least some of which may be controlled by the controller 130, are illustrated below in connection with FIGS. 3 to 5.

It will be appreciated that the apparatus 10 may comprise various further elements not discussed in detail herein. Although the apparatus 10 and the controller 130 are depicted as a single entity, different features may be implemented in one or more physical or logical entities. For instance, there may be provided a chip-set apparatus configured to carry out the control features of the controller 130. There may be further specific functional module(s), for instance for carrying one or more of the blocks described in connection with FIGS. 3 to 5. In one example variation, the proximity detection system 120 and the input surface 112 are arranged further from the display 110, e.g. on side or back (in view of the position of a display) of a handheld electronic device.

FIG. 3 shows a method for controlling scrolling according to an example embodiment. The method may be applied as a control algorithm by the controller 130, for instance. A scrolling input, referring to any type of input associated with scrolling displayed information, is detected 300. For instance, a hovering or touch input flicking on top of a window with scrollable content is detected. However, in some implementations scrolling may be initiated by some other type of input, such as by a scrollbar, a scroll wheel, arrows, shaking or any other appropriate input.

A scrolling action is initiated 310 on the basis of the scrolling input, whereby at least some of the displayed information items are moved to a direction. Often vertical scrolling is applied, but it will be appreciated that arrangement of scrolling is not limited to any particular direction. In connection with a drag input, the apparatus 10 may be arranged to scroll information items to move to a direction of the input object 100.

In block 320 a hovering input is detected based on sensed presence of an object in close proximity to an input surface during the scrolling action. In block 330 at least one parameter associated with the scrolling action is adapted in accordance with the hovering input.

It will be appreciated that the scrolling action may be controlled in various ways in block 330 in response to the detected hovering input(s), some examples being further illustrated below. It is also to be noted that the steps 320 and 330 may be repeated during a scrolling action. A plurality of different hovering inputs may be detected during a scrolling action to adapt the scrolling in accordance with user's wishes, e.g. to more quickly find a particular information item of interest. Furthermore, in one embodiment a touch input may also be required in addition to the hovering input to cause adaptation 330 of the scrolling action or to cause a specific scrolling action adaptation different from that caused based on only the hovering input. Thus, various additions and modifications may be made to the method illustrated in FIG. 3.

In some embodiments the rate of scrolling, i.e. the speed of movement of displayed information is adapted 330 in accordance with the hovering input. For instance, the controller 130 may be arranged to increase the scrolling rate in response to detecting the object 100 in the hovering area, and/or approaching the input surface 112.

In some embodiments acceleration or retardation of scrolling is adapted in response to or in accordance with the hovering input. FIG. 4 illustrates some example embodiments associated with retarding and/or accelerating the scrolling on the basis of hovering. In response to detecting 400 presence of the object in close proximity to the input surface during ongoing scrolling, the scrolling is accelerated in block 410.

In another embodiment, the displayed information may in block 410 be scrolled without retarding the scrolling rate or with reduced retardation during sensed presence of the object in close proximity to the input surface.

In a further example illustrated in FIG. 4, that may be applied after or irrespectively of block 410, in response to detecting the input object to have increased distance to the input surface, i.e. to recede 420 away from the input surface, or leave a hovering input area, the scrolling may be stopped in block 430. Thus, when a correct position is found, the user may stop the movement simply by lifting his finger further away from the input surface 112. In another embodiment a friction function or component may be initiated 430 to retard the scrolling gradually. For instance, an initial scrolling rate and retardation rate may be reinstated.

In another embodiment the interaction logic is arranged such that the controller 130 is arranged to increase the friction, i.e. retard the scrolling faster, in response to detecting the object 100 to approach the input surface 112. For example, if a list scrolls too fast, the user could slightly slow down the scrolling by bringing his finger closer to the screen 110 to better see the scrolled items.

In one example embodiment the apparatus 10 is configured to detect gestures by one or more objects (separately or in combination) in the hovering area 140. For instance, a gesture sensing functionality is activated in response to detecting 400 the hovering input object or activating 310 the scrolling action. Changes in the proximity sensing field may thus be monitored. A gesture is identified based on the detected changes. An action associated with the identified gestures may then be performed.

In some embodiments, as illustrated in the example of FIG. 5, the apparatus 10 is configured to detect 500 at least one hovering gesture as the hovering input during a scrolling action. The scrolling action may be adapted 510 in accordance with the detected hovering gesture.

In an example embodiment, the apparatus 10 is configured to detect 500 a wiggle hovering gesture, referring generally to a swipe feature over the input surface 112. The apparatus may be configured to increase scrolling speed in response to detecting the wiggle hovering gesture.

In one example, when the free movement is occurring during the scrolling action, if the user keeps his finger close to the screen, the user can wiggle his finger on this area to give more speed to the current movement of the displayed information. The user can hence “throw” the page forward, observe the initial movement, and wiggle his finger hovering over the screen to increase the scrolling speed. Each wiggle may give more speed to the movement. After applying this higher-speed movement e.g. for a predefined time period, scrolling may be retarded and thus some friction may be reapplied. The scrolling control may be arranged such that when the user stops wiggling, or after a time period after the detected wiggling gesture, the scrolling speed is controlled to return to the original speed. Thus, if the user wiggles his finger, the scrolling speed is temporarily increased. For instance, when the user moves his finger in the direction of scrolling, e.g. from top to down, the scrolling speed is increased. Similarly, when the user performs a wiggle gesture in the opposite direction, the scrolling speed is reduced (quicker). However, it will be appreciated that various other gestures, combinations of gestures, or combination of gesture(s) and tactile input(s) may be applied. As one further example, a scrolling action may be adapted 510 in response to detecting a rotation or swivel gesture.

Instead of or in addition to changing (a parameter of) an already applied scrolling function, a further function associated with scrolling may be controlled on the basis of the hovering input in block 330. For instance, the size or position of the scrolling area 1 may be changed, the scrolled content may be adapted, a further information element may be displayed, focus of scrolled information may be amended, etc.

In one embodiment appearance of one or more of the information items being scrolled is adapted in block 330 in response to detecting 320 the hovering object. For example, while scrolling web page contents, if the user's finger is detected to hover over the scrolling area 1, appearance of currently available links is changed. For instance, a web browser may be arranged to display the links as bolded or glowing. When the finger is removed, the links are displayed as in original view.

In one example embodiment the apparatus 10 is arranged to detect the vertical and/or horizontal position of the object 100 in close proximity to the input surface during the scrolling action. The at least one parameter associated with the scrolling action may be controlled on the basis of x, y position information of the object 100. Thus, different control actions may be associated with different areas of the display area with the scrollable information.

In one embodiment the current horizontal and/or vertical position of the input object 100 is detected in block 320 and the view of the scrolled information is changed in block 330 on the basis of the current horizontal and/or vertical position of the input object 100. For example, a browser view, in which page contents are being scrolled downwards as illustrated by arrow 2 in FIG. 1, the view may be changed to extend to left or right, or include items from left or right (outside original view) in accordance with the y position of the hovering object 100. The user may e.g. slightly change the scrolling view to the right by hovering the finger on right (lower) side of the window. In another the window 1 is moved sideways in accordance with detected movement of the hovering object 100 in y direction.

In some example embodiments the distance of the object 100 to the input surface 112 is estimated. At least one parameter associated with the scrolling action may then be adapted in accordance with the estimated distance. For instance, the scrolling may be accelerated, retarded, stopped in accordance with the estimated distance. There may be specific minimum and/or maximum distances defined for triggering adaptation of the scrolling action. It will be appreciated that this embodiment may be used in connection with one or more of the other embodiments, such as the embodiments illustrated above in connection with FIGS. 3 to 5.

Thus, the user may easily “fine-tune” e.g. the friction component of the scrolling action. In one embodiment, the apparatus 10 and the controller 130 may be arranged to support the following example use case: A user may initiate scrolling and keep the friction component as small as possible by maintaining the finger very close to the input surface 112. Then, when he thinks that he is close to what he is looking for, he may lift his finger a bit to get more friction and have a better view on the content. If it is still not the place he is looking for, he may again move his finger closer to the input surface 112, whereby friction is decreased and scrolling continues faster. In this way it is possible to check whether the right place has been found without interrupting the scrolling itself.

Hence, the apparatus 10 may be arranged to enable adaptation of scrolling behaviour in various ways by hovering input(s). In addition to the already above illustrated embodiments, a broad range of further functions is available for selection to be associated with an input detected by a touch sensitive detection system and/or the proximity detection system 120 during the scrolling action. The controller 130 may be configured to adapt the associations according to a current operating state of the apparatus 10, a user input or an application executed in the apparatus 10, for instance. For instance, associations may be application specific, menu specific, view specific and/or context (which may be defined on the basis of information obtained from the current environment or usage of the apparatus 10) specific. Some examples of application views, the scrolling of which may be arranged by applying at least some of the present features, include but are not limited to a browser application view, map application view, a document viewer (e.g. a book reader) or editor view, a folder view (e.g. an image, video or music gallery, etc.

In one example embodiment the proximity detection system 120 may be arranged to detect combined use of two or more objects during the scrolling operation. According to some embodiments, two or more objects 100 may be simultaneously used in the hovering area 140 and a specific scrolling control function may be triggered in response to detecting further objects.

In one example embodiment the apparatus 10 is configured to control user interface actions and the scrolling action on the basis of further properties associated with movement of the input object 100 in the hovering area 140 during the scrolling action. For instance, the apparatus 10 may be configured to control a scrolling parameter on the basis of speed of the movement of the object 100.

At least some of the above-illustrated features may be applied in connection with 3D displays. For instance, various auto-stereoscopic screens may be applied in the apparatus 10. In a 3D GUI, individual items can also be placed on top of each other, or such that certain items are located higher or lower than others. For instance, some of the scrolled information items may be displayed on top of other information items. One or more of the above-illustrated features may be applied to control scrolling in 3D display on the basis a hovering input during a scrolling action.

FIG. 6 shows a block diagram of the structure of an electronic device 600 according to an example embodiment. The electronic device may comprise the apparatus 10. Although one embodiment of the electronic device 600 is illustrated and will be hereinafter described for purposes of example, other types of electronic devices, such as, but not limited to, personal digital assistants (PDAs), pagers, mobile computers, desktop computers, laptop computers, tablet computers, media players, televisions, gaming devices, cameras, video recorders, positioning devices, electronic books, wearable devices, projector devices, and other types of electronic systems, may employ the present embodiments.

Furthermore, the apparatus of an example embodiment need not be the entire electronic device, but may be a component or set of components of the electronic device in other example embodiments. For example, the apparatus could be in a form of a chipset or some other kind of hardware module for controlling by performing at least some of the functions illustrated above, such as the functions of the controller 130 of FIG. 2. A processor 602 is configured to execute instructions and to carry out operations associated with the electronic device 600. The processor 602 may comprise means, such as a digital signal processor device, a microprocessor device, and circuitry, for performing various functions including, for example, one or more of the functions described in conjunction with FIGS. 1 to 5. The processor 602 may control the reception and processing of input and output data between components of the electronic device 600 by using instructions retrieved from memory. The processor 602 can be implemented on a single-chip, multiple chips or multiple electrical components. Some examples of techniques which can be used for the processor 602 include dedicated or embedded processor, and ASIC.

The processor 602 may comprise functionality to operate one or more computer programs. Computer program code may be stored in a memory 604. The at least one memory and the computer program code may be configured to, with the at least one processor, cause the apparatus to perform at least one embodiment including, for example, control of one or more of the functions described in conjunction with FIGS. 1 to 5. For example, the processor 602 may be arranged to perform at least part of the functions of the controller 130 of FIG. 2. Typically the processor 602 operates together with an operating system to execute computer code and produce and use data.

By way of example, the memory 604 may include non-volatile portion, such as EEPROM, flash memory or the like, and a volatile portion, such as a random access memory (RAM) including a cache area for temporary storage of data. The information could also reside on a removable storage medium and loaded or installed onto the electronic device 600 when needed.

The electronic device 600 may comprise an antenna (or multiple antennae) in operable communication with a transceiver unit 606 comprising a transmitter and a receiver. The electronic device 600 may operate with one or more air interface standards and communication protocols. By way of illustration, the electronic device 600 may operate in accordance with any of a number of first, second, third and/or fourth-generation communication protocols or the like. For example, the electronic device 600 may operate in accordance with wireline protocols, such as Ethernet and digital subscriber line (DSL), with second-generation (2G) wireless communication protocols, such as Global System for Mobile communications (GSM), with third-generation (3G) wireless communication protocols, such as 3G protocols by the Third Generation Partnership Project (3GPP), CDMA2000, wideband CDMA (WCDMA) and time division-synchronous CDMA (TD-SCDMA), with fourth-generation (4G) wireless communication protocols, such as 3GPP Long Term Evolution (LTE), wireless local area networking protocols, such as 802.11, short-range wireless protocols, such as Bluetooth, and/or the like.

The user interface of the electronic device 600 may comprise an output device 608, such as a speaker, one or more input devices 610, such as a microphone, a keypad or one or more buttons or actuators, and a display device 612 capable of displaying scrollable content and appropriate for the electronic device 600 in question.

The input device 610 may include a touch sensing device configured to receive input from a user's touch and to send this information to the processor 602. Such touch-sensing device may be configured to recognize also the position and magnitude of touches on a touch sensitive surface. The touch sensing device may be based on sensing technologies including, but not limited to, capacitive sensing, resistive sensing, surface acoustic wave sensing, pressure sensing, inductive sensing, and optical sensing. Furthermore, the touch sensing device may be based on single point sensing or multipoint sensing. In one embodiment the input device is a touch screen, which is positioned in front of the display 612.

The electronic device 600 also comprises a proximity detection system 614 with proximity detector(s), such as the system 120 illustrated earlier, operatively coupled to the processor 602. The proximity detection system 614 is configured to detect when a finger, stylus or other pointing device is in close proximity to, but not in contact with, some component of the computer system including for example housing or I/O devices, such as the touch screen.

The electronic device 600 may comprise also further units and elements not illustrated in FIG. 6, such as further interface devices, a battery, a media capturing element, such as a camera, video and/or audio module, a positioning unit, and a user identity module.

In some example embodiments further outputs, such as an audible and/or tactile output may also be produced by the apparatus 10 e.g. on the basis of the detected hovering input or hovering distance associated with or during the scrolling action. Thus, the processor 602 may be arranged to control a speaker and/or a tactile output actuator, such as a vibration motor, in the electronic device 600 to provide such further output.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer-readable storage medium that may be any media or means that can contain or store the instructions for use by or in connection with an instruction execution system, apparatus, or device, such as a computer.

If desired, at least some of the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
at least one processor; and
at least one memory including computer program code, the at least one memory and the computer program code configured to, with the at least one processor, cause the apparatus at least to:
cause a scrolling action on the basis of a scrolling input,
detect a hovering input on the basis of sensing presence of an object in close proximity to an input surface during the scrolling action, and
adapt at least one parameter associated with the scrolling action in accordance with the hovering input.

2-3. (canceled)

4. The apparatus of claim 1, wherein the apparatus is configured to adapt the rate of scrolling in accordance with the hovering input.

5. The apparatus of claim 4 wherein the apparatus is configured to adapt acceleration or retardation of scrolling in accordance with the hovering input.

6. The apparatus of claim 5, wherein the apparatus is configured to cause the displayed information to scroll without retardation or with reduced retardation during sensed presence of the object in close proximity to the input surface, and the apparatus is configured to stop the scrolling or retard the scrolling gradually in response to detecting the input object to recede from the input surface or leave a hovering input area.

7. The apparatus of claim 1, wherein the apparatus is configured to detect estimated distance of the object to the input surface, and the apparatus is configured to adapt the at least one parameter associated with the scrolling action in accordance with the estimated distance.

8. The apparatus of claim 1, wherein the apparatus is configured to detect a hovering gesture during the scrolling action, and the apparatus is configured to control the at least one parameter associated with the scrolling action in accordance with the hovering gesture.

9. The apparatus of claim 8, wherein the apparatus is configured to detect a wiggle hovering gesture during the scrolling action, and the apparatus is configured to increase the rate of scrolling in response to detecting the wiggle hovering gesture.

10. The apparatus of claim 1, wherein the apparatus is configured to detect a vertical position of the object in close proximity to an input surface during the scrolling action, and the apparatus is configured to control the at least one parameter associated with the scrolling action in accordance with the detected vertical position.

11. The apparatus of claim 1, wherein the apparatus is a mobile communications device comprising a touch screen.

12. A method, comprising:
causing a scrolling action on the basis of a scrolling input,
detecting a hovering input on the basis of sensing presence of an object in close proximity to an input surface during the scrolling action, and
adapting at least one parameter associated with the scrolling action in accordance with the hovering input.

13. The method of claim 12, wherein the rate of scrolling is adapted in accordance with the hovering input.

14. The method of claim 13, wherein acceleration or retardation of scrolling is adapted in accordance with the hovering input.

15. The method of claim 14, wherein the displayed information is scrolled without retardation or with reduced retardation during sensed presence of the object in close proximity to the input surface, and the scrolling is stopped or gradually retarded in response to detecting the input object to recede from the input surface or leave a hovering input area.

16. The method of claim 12, wherein estimated distance of the object to the input surface is detected, and the at least one parameter associated with the scrolling action is adapted in accordance with the estimated distance.

17. The method of claim 12, wherein a hovering gesture is detected during the scrolling action, and the at least one parameter associated with the scrolling action is controlled in accordance with the hovering gesture.

18. The method of claim 17, wherein a wiggle hovering gesture is detected during the scrolling action, and the rate of scrolling is adapted in response to detecting the wiggle hovering gesture.

19. The method of claim 12, wherein a vertical position of the object in close proximity to an input surface is detected during the scrolling action, and the at least one parameter associated with the scrolling action is controlled in accordance with the detected vertical position.

20. A computer program product comprising a computer-readable medium bearing computer program code embodied therein for use with a computer, the computer program code comprising:
code for causing a scrolling action on the basis of a scrolling input,
code for detecting a hovering input based on sensing presence of an object in close proximity to an input surface during the scrolling action, and
code for adapting at least one parameter associated with the scrolling action in accordance with the hovering input.
